(19) United States
(12) Patent Application Publication
(10) Pub. No.: US 2003/0154481 A1
(43) Pub. Date: Aug. 14, 2003

(54) Identification of programming having supplementary content

(76) Inventors: David B. Andersen, Hillsboro, OR (US); Sridhar Iyengar, Portland, OR (US); Paul Pilat, Portland, OR (US); Mary D. Smiley, Beaverton, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/074,484

(22) Filed: Feb. 11, 2002

(51) Int. Cl. H04N 5/445; G06F 3/00; G06F 13/00

(52) U.S. Cl. 725/47; 725/40; 725/39; 725/51

(57) ABSTRACT

A method is described for associating a predefined unique symbol with a type of supplementary content for a program, creating a program schedule that includes a listing for the program, and providing the predefined unique symbol in association with the listing in the program schedule.

### FIELD OF THE INVENTION

This invention relates to program schedules and more specifically to the identification of a specific category of programs in a program schedule.

### BACKGROUND OF THE INVENTION

It is increasingly prevalent in the network, cable, and satellite television and radio industry to provide supplementary content that relates in some manner to television or radio programs. The content may be provided in different forms, often as a set of static or interactive pages on the World Wide Web, but sometimes as web-like content, software, or other data delivered to or downloaded by a device such as a cable television set-top box in conjunction with a program broadcast.

Such content is provided across all types of fee regimes including free programming, paid cable programming and pay per view programming. In some cases, web pages are provided on the World Wide Web in conjunction with a television broadcast. In these cases, the user is said to be using a 2-screen system, one screen being the television screen and the other the screen of an Internet access device such as a personal computer or laptop, a web appliance, a personal digital assistant, or even a web-enabled cell-phone. In other instances, the video and data are integrated into a single screen, termed a 1-screen system, in enhanced television programming such as that conforming to the ATVEF specification. Advanced Television Enhancement Forum (ATVEF) Enhanced Content Specification v 1.1.r26, <http://www.atvef.com/library/spec1_{—}1a.html>, (accessed Feb. 5, 2002). In such programming, a part of the area of the display screen is used for video and the remaining area for interactive or static data display, as for example on a WebTV™ or on an AOLTV™ system. In another example of this trend, web-based content is often associated with a broadcast radio program. This practice is not restricted to broadcast programming, but could also extend to multicasting, for example, in services where selected viewers are provided with multicast video content such as start-anytime pay per view services and supplementary content associated with the video content.

Many network, cable, satellite television and radio providers make available a program schedule that lists the available programs for the benefit of a member of the program audience and enables a particular user to tune in or select the program in the manner appropriate to its type. In the broadcast television domain, for example, program schedules typically provide channel names and numbers, and a schedule grid that lists the times at which programs begin and end. Within the grid, names and, sometimes, descriptions of the programs themselves are provided. Users then may look up a program by time and channel and learn about the title and nature of the program from the entry in the grid.

Program schedules are provided in a number of different formats. Publications such as TV Guide™, local newspapers and other print media regularly print program schedules for local television stations and those carried by local cable networks. Television program schedules are available on the World Wide Web from services such as TV Guide Online™ and Yahoo™ TV; from web sites provided by the program providers as well as others and can be often customized to display the schedule for a specific audience based on geographic or administrative region, ethnic or linguistic category, programming preferences, time zone and/or other criteria.

Cable and satellite television providers also provide program schedules using a program guide channel or an electronic program guide that displays a program schedule on the user's television monitor. Electronic program guides often allow users to interact with the program schedule display by allowing user control of time period of day, type of programming, paging and other aspects of the schedule displayed. Similar schedules for radio programming are also available, also in a diverse set of formats.

Other types of programming having program schedules may have supplementary content. For example, live events such as sporting events in sports venues, theatrical entertainment, artistic performances of various kinds, as well as informational, educational or other types of lectures and presentations may also be listed in program schedules in newspapers, magazines, on the Internet and in other locations, and have supplementary content associated with the events.

Until now, a problem that has faced both providers and users of programming with supplementary content has been enabling the discovery of the existence of such content. The methods used to indicate that supplementary content existed in relation to a particular program have varied with the provider of the program and the type of the programming. For example, the existence of enhanced ATVEF content for television programs on WebTV was indicated by the appearance of a stylized “i” icon on the corner of the screen image during the program. In other services, the program provider has provided advance advertising indicating that a particular program was being provided with supplementary content. In general, however, no standard method exists today to indicate that a particular program has supplementary content associated with it. In particular, no standard method of discerning the existence of supplementary content from a program schedule listing is available today.

### BRIEF DESCRIPTION OF THE DRAWINGS

FIG. 1 is an example of a program schedule in accordance with one embodiment of the invention.

FIG. 2 is a diagram indicating the various entities involved in the activities covered by one embodiment of the invention and the interactions among them.

### DETAILED DESCRIPTION

Reference throughout this specification to “one embodiment” or “an embodiment” means that a particular feature, structure or characteristic described in connection with the embodiment of the invention is included in at least one embodiment of the invention. Thus, appearances of the phrases “in one embodiment” or “in an embodiment” in various places throughout this specification are not necessarily all referring to the same embodiment of the invention. Furthermore, the particular features, structures or characteristics may be combined in any suitable manner in one or more embodiments of the invention.

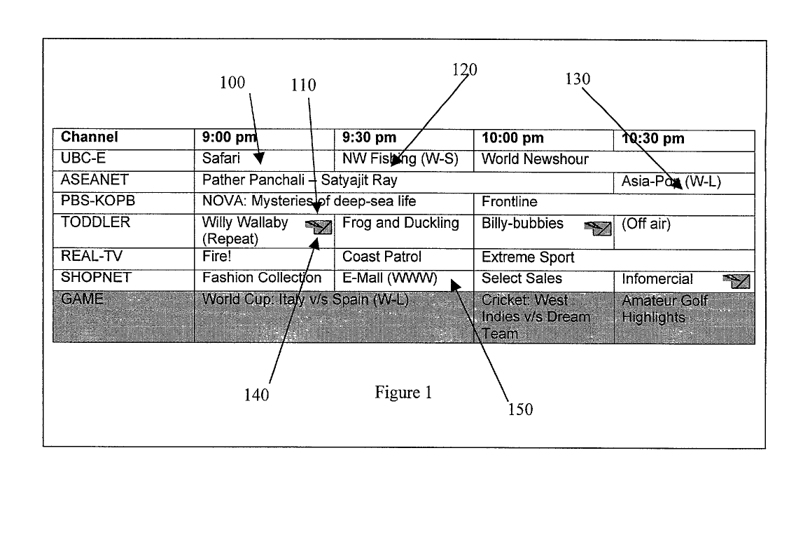

In the exemplary embodiment of the invention pictured in FIG. 1, a partial program 10 schedule is shown for a fictitious television cable channel line up. As displayed in the diagram, the schedule consists of a grid or table of program blocks 100, each of which includes at least the name of a program. In some cases as in the program block 110 the name of the program may be augmented by a brief description. Each program block corresponds to a time column and a channel row, for example the program “Safari” in block 100 is broadcast at 9:00 pm on channel UBC-E in this fictional subscriber community. In this example, it is assumed that some programs listed in the exemplary partial schedule pictured have supplementary content associated with them. In this example, it is assumed that one or more of three different types of supplementary content are provided in association with some of the television programs listed in the pictured grid.

One type of supplementary content is a set of one or more static web pages, which does not support interactivity and does not change as the associated program is broadcast, for example a set of static web pages relating to various types of fish in the Pacific Northwest that might be made available in conjunction with the program “NW Fishing” as in block 120. This type of program may be said to have “two-screen static web content,” because two screens, the television screen and a computer display, are used to present the content in conjunction with the program. The predefined unique symbol in this embodiment of the invention for programs that have two-screen static web content is the text string “(W-S)”.

Another type of supplementary content is a live or interactive web page that changes as the associated program is broadcast, for example a web page that allows viewers to send music video requests to the presenters of a live music video program “Asia-Pop” and displays the lyrics of the songs whose videos are being broadcast, as in block 130. This type of program may be said to have “two-screen interactive web content.” The predefined unique symbol for programs that have two-screen interactive web content in this embodiment of the invention is the text string “(W-L)”. In another example of such interactive content that would be identified with the “(W-L)” text string, a user might be invited to play along with a television trivia program or other game show on a related web page that changes in real time as the game progresses on television.

In a variation of this embodiment of the invention, a program having any supplementary web content related to it is designated by the predefined unique symbol “WWW” associated with its listing in a program schedule, regardless of whether the content is static or interactive, as in block 150.

In yet another example of supplementary content, some programs in this embodiment of 20 the invention allow interactivity with a television image on a single screen in conjunction with a digital set top box. This type of program is referred to as “having 1-screen interactive content“or “a 1-screen enhancement.” For example, in block 140, the show “Willy Wallaby” has associated with it 1-screen supplementary content that is transmitted in association with the program, by means of an ATVEF enhancement viewable on a digital set top box designed to receive it. A predefined unique symbol denoting programs with one-screen interactive content in this example is a graphic including a lightning bolt and a diagonally split rectangle.

It should be noted that the actual types of supplementary content and the predefined unique symbols for denoting such content, as described above, are merely examples to illustrate the invention. In other embodiments of the invention, there may be additional or other types of supplementary content not described above; and the set of symbols, graphic logos and text strings used to symbolize the types of supplementary content may differ from the ones depicted in the figure. In some embodiments of the invention these symbols, logos or text strings may be animated or dynamic, changing in appearance, blinking, or flashing when presented on a display device.

Further, it should be noted that the examples described above are independent of the actual medium over which the program schedule is provided to a user. The medium may be a print, television, web-based or other electronic medium, among others. In other embodiments of the invention the program schedule may not appear as depicted in the figure and may forego specific elements such as grid lines, or an arrangement as depicted. The program schedule and any text in the standardized symbols may not be in the English language or in any printed language, but may be in other written languages or in a tactile language such as Braille.

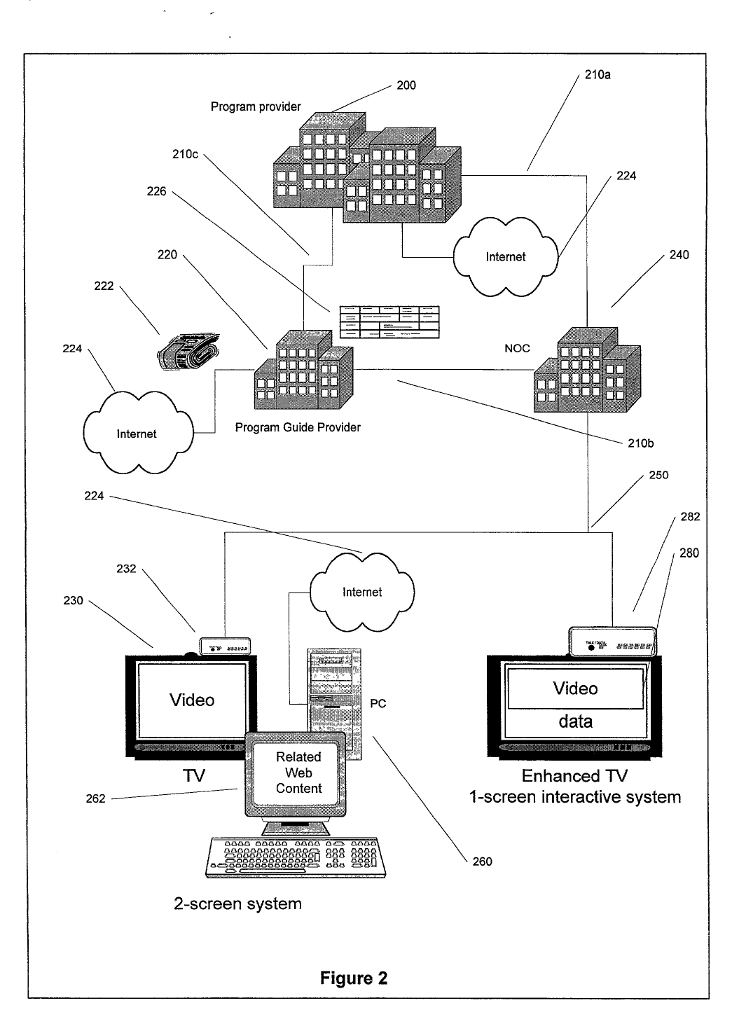

In FIG. 2, components that are involved in one embodiment of the invention and their interactions are depicted. The following description relates to FIG. 2.

A Program Provider 200 distributes programs such as television programs to an audience, in this embodiment of the invention by distributing television programming via a communication link 210a such as a satellite uplink/downlink to one or more Network Operating Centers (NOCs) exemplified in the figure by 240. The Program Provider may also provide supplementary content related to the programs. This content may be provided as data transmitted with the programs to the NOCs as enhancements to the programs, and/or it may be provided as content on the Internet 224.

In addition, the Program Provider provides program information to a Program Guide Provider 220 over a communication link 210c such as a private data network, and/or over a public network such as the Internet 224. Included in this program information is information about the type of supplementary content related to a program if such content is available, as well as scheduling and other descriptive information.

The Program Guide Provider 220 uses program information from one or more Program Providers to create a program guide or program schedule 226, such as the one described above and depicted in FIG. 1, including predefined unique symbols in association with listings of programs that have supplementary content. The Program Guide Provider may then provide the program schedule in different forms, for example, it may be printed in a newspaper 222 or in another print format; it may be distributed to the public at large over the Internet 224; and it may be transmitted by communication link 210b to the NOC 240.

In the latter two cases, the program schedule may be active as indicated earlier in the description of FIG. 1. First, the program schedule distributed over the Internet may incorporate a predefined unique symbol in association with programs having supplementary content, as described above, and those symbols on the web content representing the program guide 226 may allow a viewer of the program guide on the Internet to obtain the supplementary content by clicking or selecting the symbols from a suitable Internet access device, including a home PC 260, or alternatively a notebook computer, Web appliance, PDA or web-enabled cellular phone, among others. In one embodiment of the invention, the program schedule distributed on the Internet is provided as set of HTML compliant web pages, within which the predefined unique symbols associated with program listings are provided as selectable page elements such as text hyperlinks as provided for by HTML, where the displayed text of the hyperlink is a text string used as a predefined unique symbol. W3C, HTML 4.01 Specification, <http://www.w3.org/TR/html4/> (Dec. 4, 1999). Alternatively a selectable page element may be a embedded hyperlink associated with an image or graphic logo representing the predefined unique symbol, and incorporated into the HTML web pages as provided for in the HTML specification. The hyperlink incorporates an URL as provided in the HTML specification, redirecting the user's web access device or software to a location where the supplementary content associated with the program is provided when the hyperlink is selected.

A person skilled in the art will appreciate that other formats for presentation of content and mechanisms for user-controlled navigation between locations on the World Wide Web may be used to achieve the same results.

Second, the program schedule distributed using the NOC may be provided in an Electronic Program Guide (EPG) to a user of an enhanced television system 280 and 282, allowing such a viewer to directly select a predefined unique symbol representing a program with supplementary content using the user interface and data access capabilities of such an enhanced television system. The enhanced television system may then present the supplementary content directly to the user either in a data-only format similar to that provided by a web browser or in a combined format with video and data displayed simultaneously on different portions of the screen, as is possible with an ATVEF presentation transmitted to an enhanced television capable of receiving ATVEF content in conjunction with video.

The NOC 240 transmits the programs provided by the Program Provider over a consumer network 250 using, for example, a television communication standard such as ATSC (Advanced Television Systems Committee, ATSC Standard: Digital Television Standard, Revision B, <http://www.atsc.org/standards/a_{—}53b.pdf > (Aug. 7, 2001)) or alternatively via a direct-to-consumer satellite transmission system. The NOC also transmits the program schedule 226 that is received from the Program Guide Provider over the consumer network 250 either as a video channel to a cable television tuner 232, or as Electronic Program Guide (EPG) data presented to an enhanced television set top box 282.

The viewer or user of the programs provided by the Program Provider via the NOC may use either a conventional television monitor 230 coupled to a cable television tuner 232 to view video content and in conjunction with the television system comprising 230 and 232, use a personal computer (PC) 260 such as a Windows™ PC powered by an Intel™ processor or other computer to view the content related to the programs on the Internet. Alternatively the viewer may use an enhanced television system comprising an enhanced television set top box 282 such as a digital television receiver with ATVEF or other data reception capabilities, and a monitor 280, capable of being used in conjunction with a pointing device such as a remote control unit, or a mouse in communication with a computer, in order to select items on the screen.

In the former case, the viewer of the conventional television system 230 and 232 may view the program schedule or guide 226 as a television guide channel received and viewed as an ordinary television channel. In this case, the viewer would become aware that a program was provided with supplementary content by looking at a listing of the program on the television guide channel and noting that a predefined unique symbol denoting the existence of such content was displayed in association with the program. The viewer then may access the content using a home PC connected to the Internet 224 in the 2-screen system pictured, with video displayed on television monitor 230 and web content presented on display device 262, using an URL or other information that may be provided with the program listing. Alternatively, the viewer may access the program schedule on the Internet 224 using the PC 260 and may, if such a program guide allows active selection, select the predefined unique symbol from a listing of the program in the guide and so access the web content directly for viewing on the PC display.

The viewer may alternatively view the program guide as an Electronic Program Guide (EPG) on the enhanced television system 280, 282. The predefined unique symbol displayed in conjunction with program listings in the EPG may then be directly selectable by the viewer using a remote control, mouse, or other selection device connected to the enhanced television system, causing the system to display the supplementary content either in combination with the video for the program in an enhanced ATVEF or other video and data combination mode, or in a web browser-like mode where the entire screen area is used to display the supplementary content alone.

As indicated, the described entity-relationship diagram is merely one exemplary embodiment of the invention and is not intended to limit the invention. Many other modes of use of the invention are possible. For example, the Program Provider and Program Guide Provider may be the same entity. Alternatively, multiple Program Guide Providers may exist supplying the viewer with program schedules in different forms. Different modes of communication may be used between the various entities. In one mode, for example, the program guide may be transmitted from the Program Guide Provider to the NOC using a physical medium such as a removable disk or tape, or alternatively over an analog or digital telephone line.

Further, the combinations of viewing equipment that the end user may employ are diverse and may include both an enhanced television system and a home PC; a home PC configured to act as either a conventional or enhanced television system by software; a digital and/or analog television display system; a digital and/or analog television receiver; one or more PCs and other digital devices capable of displaying television content, web content, and/or other interactive and static digital content, in some cases using a home network. The cable television set top box or enhanced television set top box may simultaneously provide access to the Internet. There may be no cable television reception at all and the program and program guide transmission may be broadcast over the air and received by a user's antenna.

Also note that this embodiment of the invention uses a television program merely as an example. However, there are no limitations to the use of the invention for a completely different form of programming with supplementary content for which a program guide or schedule might be distributed. This may be for example, radio programming, including digital and satellite radio programming, or another form of content distribution outside the traditional broadcast model such as a multicast, including for example start-on-demand pay per view systems; live events which may or may not be broadcast or transmitted, such as sporting events in sports venues, theatrical entertainment, artistic performances of various kinds, as well as informational, educational or other types of lectures and presentations.

An embodiment of the invention may be performed by hardware components, or may be embodied in machine-executable instructions, which may be used to cause a general-purpose or special-purpose processor or logic circuits programmed with the instructions to perform the invention. Alternatively, the invention may be performed by a combination of hardware and software. The invention may be provided as a computer program product that may include a machine-readable medium having stored thereon data which when accessed by a machine may cause the machine to perform a process according to the invention. The machine-readable medium may include, but is not limited to, floppy diskettes, optical disks, CD-ROMs, and magneto-optical disks, ROMs, RAMs, EPROMs, EEPROMs, magnet or optical cards, flash memory, or other type of media/machine-readable medium suitable for storing electronic instructions. Moreover, the invention may also be downloaded as a computer program product, wherein the program may be transferred from a remote computer to a requesting computer by way of data signals embodied in a carrier wave or other propagation medium via a communication link (e.g., a modem or network connection).

Many aspects of the invention are described in their most basic form but can be without departing from the basic scope of the invention. It will be apparent to those skilled in the art that many further modifications and adaptations can be made. The particular embodiments of the invention described above are not provided to limit the invention but to illustrate it. The scope of the invention is not to be determined by the specific examples provided above but only by the claims below.

What is claimed is:

1. A method comprising:
creating a program schedule that includes a listing for a program that has supplementary content;
associating a predefined unique symbol with a type of the supplementary content; and
providing the predefined unique symbol in association with the listing in the program schedule.

2. The method of claim 1 wherein the program is a television program.

3. The method of claim 1 wherein the supplementary content is provided on the World Wide Web.

4. The method of claim 1 wherein the predefined unique symbol is a text string.

5. The method of claim 1 wherein the predefined unique symbol is the text string “WWW”.

6. The method of claim 1 wherein the predefined unique symbol is a graphic symbol.

7. The method of claim 1 wherein the predefined unique symbol is an image.

8. The method of claim 1 further comprising distributing the program schedule.

9. The method of claim 8 further comprising:
printing the program schedule in a publication; and
printing the predefined unique symbol in the publication.

10. The method of claim 8 further comprising:
transmitting the program schedule; and
transmitting the predefined unique symbol.

11. The method of claim 10 further comprising transmitting data which when accessed by a machine causes the machine to display an animated version of the predefined unique symbol.

12. The method of claim 8 further comprising:
making the program schedule available on the World Wide Web; and
providing the predefined unique symbol in association with the listing in the program schedule on the World Wide Web.

13. The method of claim 12 further comprising:
providing a selectable element in association with the predefined unique symbol on the World Wide Web; and
enabling provision of the supplementary content in response to selection of the selectable element by a user.

14. A method comprising:
receiving a program schedule, the program schedule further comprising:
a listing for a program that has supplementary content; and
a predefined unique symbol in association with the listing, where the predefined unique symbol is associated with a type of the supplementary content; and
sending the program schedule to a display.

15. The method of claim 14 further comprising:
receiving a signal corresponding to selection of the predefined unique symbol by a user; and
communicating with a device, causing it to present the supplementary content in response to the signal.

16. The method of claim 14 further comprising:
receiving an animated version of the predefined unique symbol; and
sending the animated version of the predefined unique symbol to the display.

17. A method comprising:
distributing a program to an audience, where the program has supplementary content;
distributing the supplementary content to the audience, where a type of the supplementary content is associated with a predefined unique symbol; and
providing listing information for the program.

18. The method of claim 17 wherein the program is a television program.

19. The method of claim 17 wherein the supplementary content is made available on the World Wide Web.

20. The method of claim 17 wherein the predefined unique symbol is a text string.

21. The method of claim 17 wherein the predefined unique symbol is the text string “WWW”.

22. The method of claim 17 wherein the predefined unique symbol is a graphic symbol.

23. The method of claim 17 wherein the predefined unique symbol is an image.

24. An apparatus comprising:
a receiver to receive a transmission comprising a program schedule, the program schedule further comprising:
a listing for a program that has supplementary content; and
a predefined unique symbol in association with the listing, where the predefined unique symbol is associated with a type of the supplementary content;
a display component coupled to the receiver to display the program schedule on a display device and to display the predefined unique symbol on the display device.

25. The apparatus of claim 24 further comprising:
an input device to receive a signal corresponding to selection of the predefined unique symbol on the display device by a user; and
a content delivery component to provide the supplementary content in response to the signal.

26. A machine accessible medium comprising data that when accessed by a machine causes the machine to perform actions according to the method of claim 14.

27. A machine accessible medium comprising data that when accessed by a machine causes the machine to perform actions according to the method of claim 15.

28. A machine accessible medium comprising data that when accessed by a machine causes the machine to perform actions according to the method of claim 16.
